(19) United States
(12) Patent Application Publication
(10) Pub. No.: US 2022/0047126 A1
(43) Pub. Date: Feb. 17, 2022

(54) PERSONAL HYGIENE DEVICE

(71) Applicant: Melissa Jackson, Houston, TX (US)

(72) Inventor: Melissa Jackson, Houston, TX (US)

(21) Appl. No.: 17/128,979

(22) Filed: Dec. 21, 2020

Related U.S. Application Data
(60) Provisional application No. 63/064,986, filed on Aug. 13, 2020.

(51) Int. Cl. A47K 7/02; B32B 5/02; B32B 5/18; B32B 5/24; B32B 25/10; B32B 27/30; B32B 27/12; B32B 7/09

(52) U.S. Cl. CPC A47K 7/024; B32B 5/028; B32B 5/18; B32B 5/245; B32B 25/10; B32B 2555/00; B32B 27/12; B32B 7/09; B32B 2266/0207; B32B 2307/744; B32B 27/306

(57) ABSTRACT

A personal hygiene device that includes a front side and a base. The front side has a cleaning surface comprising a mesh material configured for exfoliating a user's skin. The base is configured for coupling the device to surface, such as a bathroom surface. In aspects, the bathroom surface is a side of a bathtub or shower wall.

### BACKGROUND

### Field of the Disclosure

This disclosure generally pertains to a device usable for personal hygiene care. In particular, the disclosure pertains to a device operable to clean and/or exfoliate a user's backside. The device may be purchased in a manner that supports part of a treatment or care process for individuals in need.

### Background of the Disclosure

The assault on the human population by the Covid-19 virus has raised the bar on awareness of personal hygiene. While greater attention is rightfully focused on face masks and hand sanitizer, other hygienic concerns have been left behind. For example, the age-old problems associated with washing one's back has never really been solved.

Long-handled scrub brushes are known and are used, but these devices are difficult to use and ineffective as a result of the fact that full back coverage or adequate scrubbing action is often lacking. Also, when one is taking a shower, vigorous scrubbing action is difficult work and many people quickly tire of reaching behind their back. One may need to undertake a number of contortions and awkward movements in order to achieve some level of success.

The known art also includes a variety of hydraulic or motor driven devices for scrubbing and massaging one's back area to overcome the need to manually scrub the back with the hands and arms. Many of these devices are also intended to be hard-mounted to a shower wall for use during bathing.

The prior art has attempted to address this problem by providing some other solutions. For example, commercially available brushes, similar to a back scratcher, allow individuals to reach hard to get at spots on their backs. Likewise, there are straps made of loofah or other suitable material that allow an individual to hold both ends of the strap and use it to exfoliate the skin on their back. However, this does not help an individual who is disabled and cannot use their hands to control one of these devices. While difficult for most, good hygiene is even more problematic for the elderly or physically disabled, who may be unable to clean their own back area.

However, while these known scrubbing devices may be suitable for their respective purposes, they are replete with disadvantages. Examples being the complexity of the design, the cost of replacing worn components, and the likelihood of failure of mechanical parts.

While the prior art has provided some solutions that work for able-bodied individuals that do not have any handicaps, it has failed to provide a way for disabled individuals to clean and exfoliate their backs. It would be desirable to have a device that anyone can use to clean their back, whether they are disabled or not, but particularly for anyone having an affliction that inhibits or hinders normal range of motion.

A need exists for a personal hygiene device which will make it easy for a user to clean his or her back.

### SUMMARY

Embodiments of the disclosure pertain to a personal hygiene device that may include one or more of: a front side cleaning surface comprising a mesh material configured for exfoliating a user's skin; and a base configured for coupling the device to a bathroom surface.

In aspects, the bathroom surface may include one of a bathtub or a shower wall. The personal hygiene device may include an interface. The interface may include one of threads, fishing line, zip ties, and combinations thereof. In aspects, the interface may be configured to couple the front side and the base together. Just the same, the front side cleaning surface and the base may be integral to each other.

The base may include a plurality of suction cups. The base may include double-sided tape. The device may be cleaned by using water and liquid soap. The device may be suitable to air dry on its own. The front side cleaning surface may be multi-colored. The base comprises a grid-structure configured with a plurality of support elements. The base may be made of a material comprising one of foam, rubber, foam rubber, ethylene-vinyl acetate, and combinations thereof.

In aspects, a user of the device may have an affliction of disease or disability that hinders normal range of body movement. The user may purchase or acquire the device in a transaction, for which proceeds of the transaction may be used in connection with financial support of a medical treatment facility or process.

Yet other embodiments of the disclosure pertain to a personal hygiene device that may include a front side cleaning surface comprising a mesh material configured for exfoliating a user's skin; a base configured for coupling the device to a bathroom surface; and an interface for coupling, at least partially, the front side with the base.

The bathroom surface may include one of a bathtub or a shower wall. The interface may be any one of threads, fishing line, zip ties, and combinations thereof.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1A shows a downward view of a front side portion of a personal hygiene device according to embodiments of the disclosure;

FIG. 1B shows an upward view of a back side portion of the personal hygiene device of FIG. 1A according to embodiments of the disclosure;

FIG. 1C shows a close-up view of the back side portion of FIG. 1B according to embodiments of the disclosure;

FIG. 1D shows a partial view of a user using a personal hygiene device that is coupled with a surface according to embodiments of the disclosure;

FIG. 2 shows a side profile view of bath assistance unit configured with a personal hygiene device according to embodiments of the disclosure;

FIG. 3 shows a block diagram view of a user of a personal hygiene device in support of a treatment process according to embodiments of the disclosure;

FIG. 4A shows a back side view of a personal hygiene configured with a second material according to embodiments of the disclosure; and

FIG. 4B shows a partial back side view of a personal hygiene configured with an intermediate material according to embodiments of the disclosure.

### DETAILED DESCRIPTION

Regardless of whether presently claimed herein or in another application related to or from this application, herein disclosed are novel devices, apparatuses, units, systems, and methods that pertain to improved personal hygiene.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, melt index, etc., is from 100 to 1,000. it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of reactants, surfactants, catalysts, etc. by itself or in a mixture or mass, and various temperature and other process parameters.

### Terms

The term “connected” as used herein may refer to a connection between a respective component (or subcomponent) and another component (or another subcomponent), which may be fixed, movable, direct, indirect, and analogous to engaged, coupled, disposed, etc., and may be by screw, nut/bolt, weld, and so forth. Any use of any form of the terms “connect”, “engage”, “couple”, “attach”, “mount”, etc. or any other term describing an interaction between elements is not meant to limit the interaction to direct interaction between the elements and may also include indirect interaction between the elements described.

The term “mounted” as used herein may refer to a connection between a respective component (or subcomponent) and another component (or another subcomponent), which may be fixed, movable, direct, indirect, and analogous to engaged, coupled, disposed, etc., and may be by screw, nut/bolt, weld, and so forth.

The term “exfoliate” as used herein may refer to the ability or process of using a device of the present disclosure to remove dead cells from the surface of the skin.

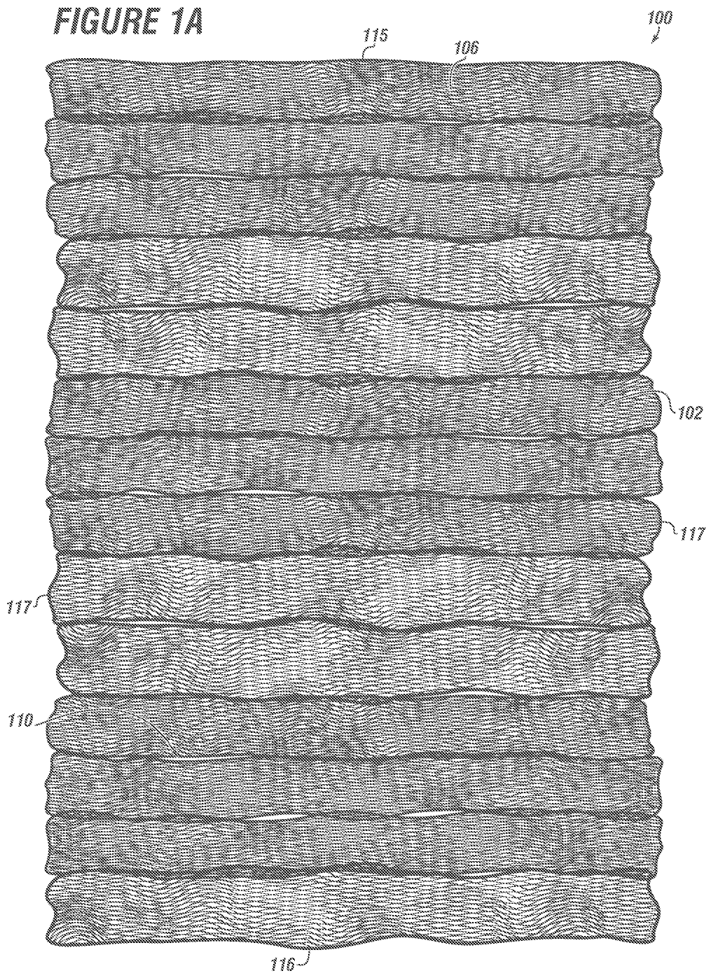

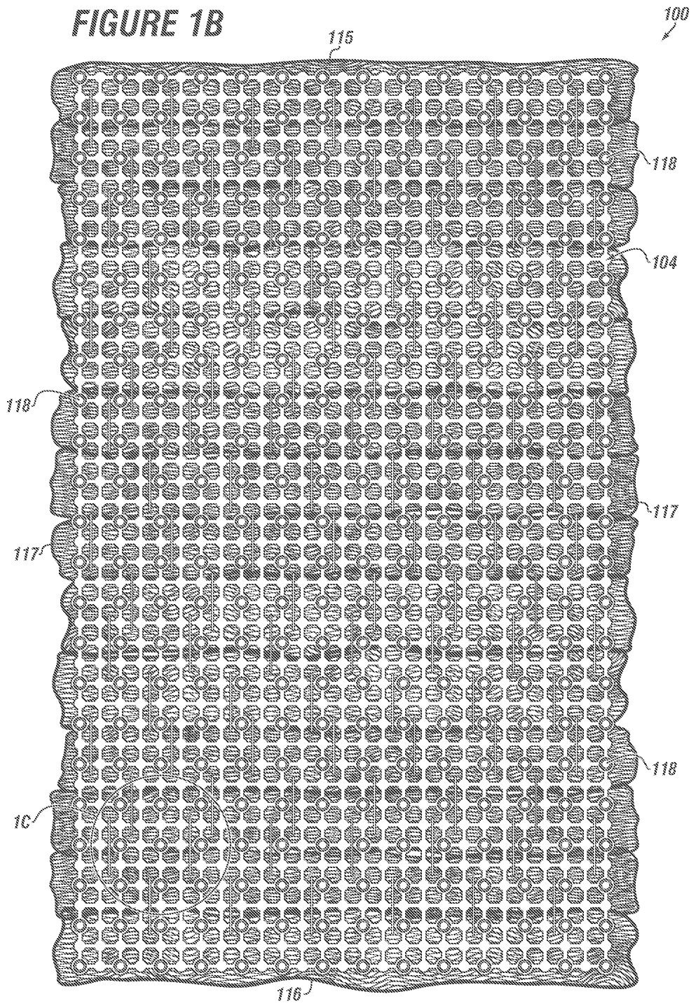

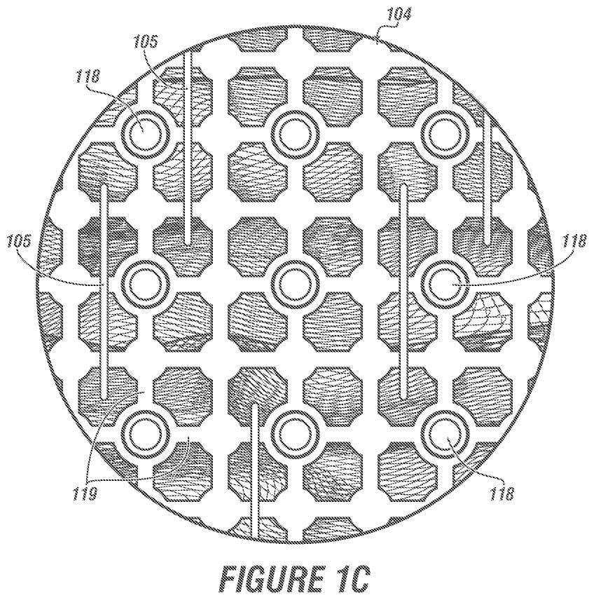

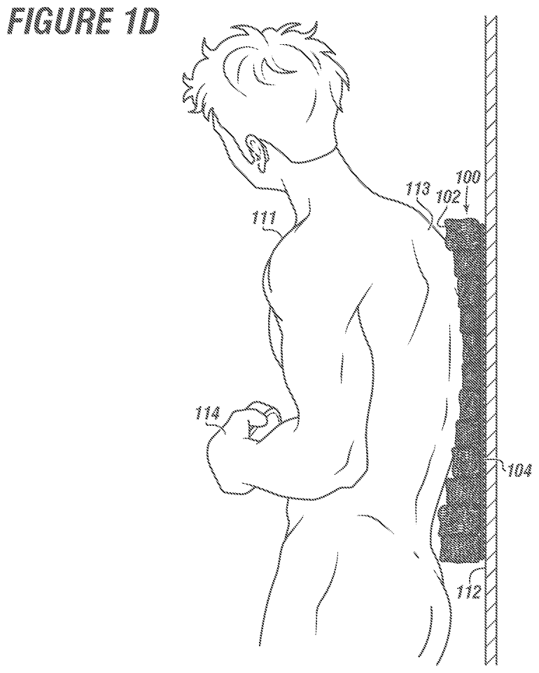

Referring now to FIGS. 1A-1D together, a downward view of a front side portion and an upward view of a back side portion, respectively, of a personal hygiene device, a close-up view of the back side portion, and a partial view of a user using the hygiene device that is coupled with a surface, illustrative of embodiments disclosed herein, are shown.

FIGS. 1A, 1B, and 1C together show a personal hygiene device 100. The device 100 may be coupled to a surface 112, which may be a bathroom surface. The bathroom surface 112 may be a sidewall of a shower or tub, and as such, use of the device 100 may be while showering or bathing to engage a back 113 of a user 111.

The device 100 may have a first portion or surface 102. The first portion 102 may be an exterior surface configured for cleaning or exfoliating the skin or back 113 of the user 111. The first portion 102 may be an (inter)woven layer of mesh strands 108. As such the first portion 102 may be firm or rigid enough to promote cleaning, yet at the same time be soft and pliable in order to provide comfort and ease of use.

The first portion 102 may have a porosity associated therewith. As such, the layer of mesh 108 may have one or more pocket gaps 110. The mesh 108 and pocket gaps 110 may provide the ability for the device 100 to be readily and easily cleaned. The device 100 may be cleaned with a simple solution of soap (such as liquid soap) and water, such as from a spray (shower) nozzle.

It is worth noting that the personal hygiene device 100 need not be limited to any particular shape or size. And so although shown by way of example here as having a rectangular shape with a nominal thickness, the device 100 may have other shapes, such as oval, elliptical, triangular, etc., with varied thickness.

The personal hygiene device 100 may have a top side 115, a bottom side 116, and left/right sides 117. The device 100 may have a second portion or base 104. The second portion 104 may be configured as an adhesion surface 104, whereby the device may be readily attached to the external surface 112. The adhesion surface 104 may also be configured for easy, non-destructive removal from the surface 112. The adhesion surface 104 may be or include one or more suction cups 118. The suction cups 118 may be oriented in a symmetrical distribution of rows and columns; however, other arrangements are possible. Generally, the cups 118 may be configured in a manner that aids restraint of the device 100 on or against the surface 112 while the device 100 is being used. The base 104 need not have suction cups 118.

The base 104 may a solid backing. FIG. 1D in particular illustrates a close-up view of a front portion 102 and base 104 coupled together with an interface 105. As shown, the base 104 be a grid-like structure with support elements 119 having cups 118 affixed thereon, respective elements being separated by openings or gaps 120.

The base 104 may be any suitable material, such as foam, rubber, foam rubber, plastic, ethylene-vinyl acetate (EVA), combinations thereof, and the like. The base 104 may have a ‘no slip’ property, which may further aid support of the device 100 on the surface 112. The base 104 may have in addition or in the alternative other adhesion support thereon, such as double-sided tape.

The first portion 102 and the second portion 104 may be integral to each other, such that the device 100 may have a unitary, one-piece configuration. Just the same, the device 100 may be multi-component. As such, the first portion 102 and the second portion 104 may be coupled together via an interface or coupler portion 105. The coupler portion 105 may be an adhesive, such as glue or tape, or other form, such threading (fabric, fishing line, etc.).

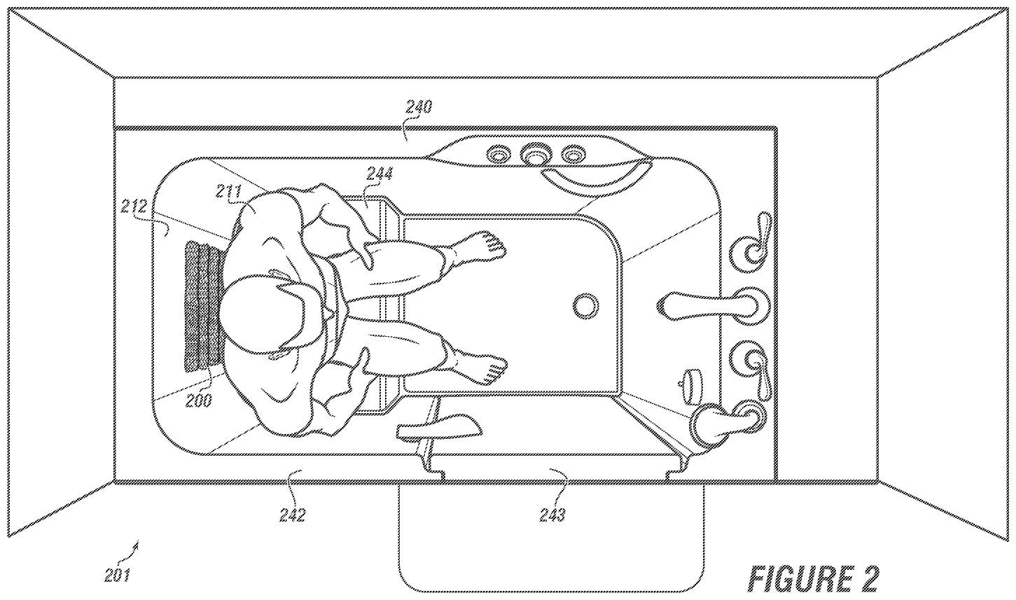

Referring now to FIG. 2, a side profile view of bath assistance unit configured with a personal hygiene device, illustrative of embodiments disclosed herein, is shown. FIG. 2 illustrates a user 211 having an affliction, such as impairment or disability, for which the bath assistance unit 240 may be useful.

The bath assistance unit 240 may be a hybrid type of shower/bath unit, whereby a user 211 may take a bath, even though a tub 242 may have a doorway 243 opening akin to that of a shower. In analogous sense, the user 211 may just as well take a shower, while able to sit down on a seat 244.

The bath assistance unit 240 may have a personal hygiene device 200 coupled therewith, such as onto support surface 212. The use of the device 200 and unit 240 may be an overall hygiene system 201. The device 200 may be comparable or identical in aspects, function, operation, components, etc. as that of other device embodiments disclosed herein (e.g., 100). Similarities may not be discussed for the sake of brevity.

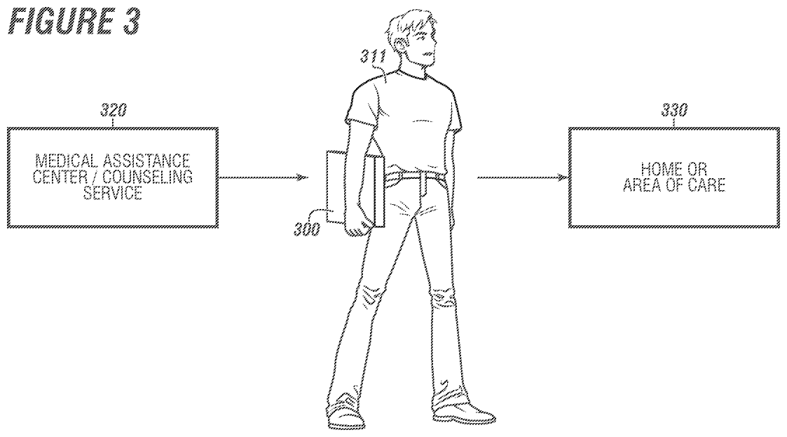

Referring now to FIG. 3, a block diagram view of a user of a personal hygiene device in support of a treatment process, illustrative of embodiments disclosed herein, is shown. FIG. 3 illustrates the personal hygiene device 300 may be directly or peripherally related to an overall care service 320.

The device 300 may be comparable or identical in aspects, function, operation, components, etc. as that of other device embodiments disclosed herein (e.g., 100). Similarities may not be discussed for the sake of brevity. As shown here, the care service 320 may be a medical facility, such as a clinic or hospital. The care service 320 may provide transient or temporary care to those in dire need, but only on a temporary basis. The care service 320 may be provided by a faith-based institution or its members.

When a user or buyer 311 purchases the personal hygiene device, proceeds from that transaction may be used to support the care service 320, in part or in whole.

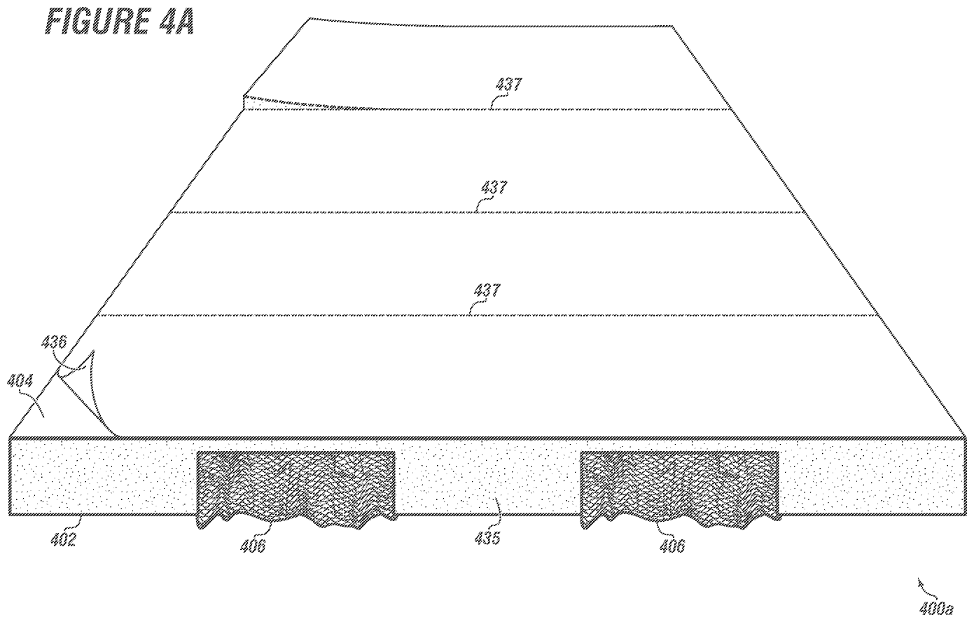

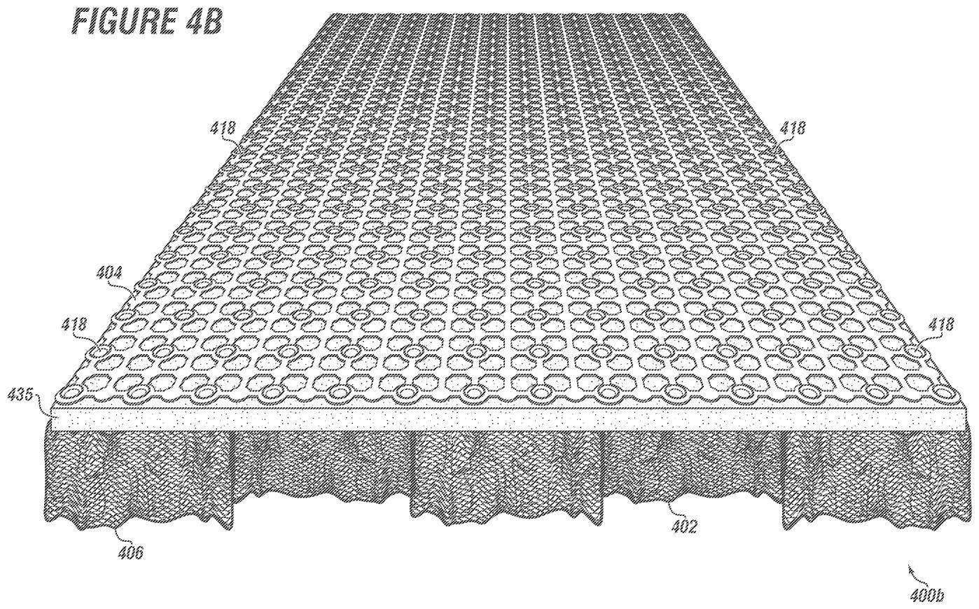

Referring now to FIGS. 4A and 4B, a back side view of a personal hygiene configured with a second material and a partial back side view of a personal hygiene configured with an intermediate material, illustrative of embodiments disclosed herein, are shown.

FIG. 4A illustrates an alternative embodiment of a personal hygiene device 400A having a first portion or surface 402, and a second portion or surface 404. The device 400A may be comparable or identical in aspects, function, operation, components, etc. as that of other device embodiments disclosed herein (e.g., 100). Similarities may not be discussed for the sake of brevity. As shown here, the device 400A may include a pliable mesh 406 coupled with a second or intermediate material 435. The second material 435 may be of different texture, toughness, etc. from that of the mesh 406. For example, the second material 435 may be spongey in nature.

The second portion 404 may be configured for coupling to a surface. The second portion 404 may include a removable backing 436, that may result in exposing an adhesive or other suitable material for coupling the device 400A with the surface. The backing 436 may have one or more perforations 437, which may make removal of the backing 436 easier.

FIG. 4B illustrates an alternative embodiment of a personal hygiene device 400B having a first portion or surface 402, and a second portion or surface 404. The first portion 402 and the second portion 404 may be coupled together. The device 400B may be comparable or identical in aspects, function, operation, components, etc. as that of other device embodiments disclosed herein (e.g., 100). Similarities may not be discussed for the sake of brevity. As shown here, the device 400B may include a pliable mesh 406 coupled with a second or intermediate material 435. The second material 435 may be of different texture, toughness, etc. from that of the mesh 406. For example, the second material 435 may be spongey in nature. As illustrated here, the second material 435 may be disposed between the first portion 402 and the second portion 404. The second portion 404 may be configured for coupling to a surface.

While preferred embodiments of the disclosure have been shown and described, modifications thereof may be made by one skilled in the art without departing from the spirit and teachings of the disclosure. The embodiments described herein are exemplary only and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the present disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A personal hygiene device comprising:
a front side cleaning surface comprising a mesh material configured for exfoliating a user's skin; and
a base configured for coupling the device to a bathroom surface;
wherein the bathroom surface comprises one of a bathtub or a shower wall.

2. The personal hygiene device of claim 1, the hygiene device further comprising an interface.

3. The personal hygiene device of claim 2, wherein the interface comprises one of threads, fishing line, zip ties, and combinations thereof, and wherein the interface is configured to couple the front side and the base together.

4. The personal hygiene device of claim 1, wherein the front side cleaning surface and the base are integral to each other.

5. The personal hygiene device of claim 1, wherein the base comprises a plurality of suction cups.

6. The personal hygiene device of claim 5, wherein the base comprises double-sided tape.

7. The personal hygiene device of claim 1, wherein the device is cleaned by using water and liquid soap, and wherein the device air dries on its own.

8. The personal hygiene device of claim 1, wherein the front side cleaning surface is multi-colored.

9. The personal hygiene device of claim 1, wherein the base comprises a grid-structure configured with a plurality of support elements.

10. The personal hygiene device of claim 1, wherein the base is made of a material comprising one of foam, rubber, foam rubber, ethylene-vinyl acetate, and combinations thereof.

11. The personal hygiene device of claim 1, wherein a user of the device has an affliction of disease or disability that hinders normal range of body movement.

12. The personal hygiene device of claim 1, wherein the user purchases the device in a transaction, for which proceeds of the transaction are used in connection with financial support of a medical treatment facility or process.

13. A personal hygiene device comprising:
a front side cleaning surface comprising a mesh material configured for exfoliating a user's skin;
a base configured for coupling the device to a bathroom surface; and
an interface for coupling, at least partially, the front side with the base,
wherein the bathroom surface comprises one of a bathtub or a shower wall.

14. The personal hygiene device of claim 13, wherein the interface comprises one of threads, fishing line, zip ties, and combinations thereof.

15. The personal hygiene device of claim 14, wherein the base comprises a plurality of suction cups.

16. The personal hygiene device of claim 15, wherein the base comprises double-sided tape.

17. The personal hygiene device of claim 16, wherein the device is wherein the front side cleaning surface is multi-colored.

18. The personal hygiene device of claim 17, wherein the base comprises a grid-structure configured with a plurality of support elements.

19. The personal hygiene device of claim 17, wherein the base is made of a material comprising one of foam, rubber, foam rubber, ethylene-vinyl acetate, and combinations thereof.

20. The personal hygiene device of claim 19, wherein a user of the device has an affliction of disease or disability that hinders normal range of body movement, and wherein the user purchases the device in a transaction, for which proceeds of the transaction are used in connection with financial support of a medical treatment facility or process.
